(19) United States
(12) Patent Application Publication
(10) Pub. No.: US 2012/0007395 A1
(43) Pub. Date: Jan. 12, 2012

(54) Auxiliary Bicycle Seat

(75) Inventor: Jess Colton, Orem, UT (US)

(73) Assignee: Jess Colton, Orem, UT (US)

(21) Appl. No.: 13/180,787

(22) Filed: Jul. 12, 2011

Related U.S. Application Data
(60) Provisional application No. 61/363,406, filed on Jul. 12, 2010.

(51) Int. Cl. B62J 1/00; B23P 11/00

(52) U.S. Cl. 297/195.13; 29/428

(57) ABSTRACT

An auxiliary bicycle seat is disclosed herein designed for the transport of a subject or object on a bicycle.

### RELATED APPLICATION

This application claims the benefit of U.S. Provisional Application No. US 61/363,406, filed on Jul. 12, 2010. The entirety of which is incorporated by reference herein.

### TECHNICAL FIELD

This disclosure relates to a device for use with a bicycle. More particularly, this disclosure relates to an auxiliary bicycle seat for the transport of a subject on a bicycle.

### BACKGROUND

Bicycles may be used to transport individuals and equipment efficiently and safely. Many bicycles are designed only for one individual operator having only one primary or main bicycle seat or saddle. However, it may be desirable to position an additional individual or subject on a bicycle originally designed for a single operator. This may be accomplished by providing an auxiliary bicycle seat or saddle designed to accommodate another passenger on the bicycle. Additional background information related to the use of auxiliary bicycle seats may be found in the following publications which are incorporated in their entirety by reference herein:
U.S. Pat. No. 3,738,704 issued Jun. 12, 1973 to Lloyd H. Smith—Stem Mount
U.S. Pat. No. 3,902,737 issued Sep. 2, 1975 to Ivin E. Berger—Head Tube Mount
U.S. Pat. No. 4,305,532, issued Dec. 15, 1981 to John F. Reminger—Cross-member style
U.S. Pat. No. 5,104,188, issued Apr. 14, 1992 to Malcolm Jefferson—Cross-member style
U.S. Pat. No. 7,044,541, issued May 16, 2006 to Che Eissinger—Stem Mount (iBert safe-T-seat)
U.S. Pat. No. 7,523,986, issued Apr. 28, 2009 to Malcolm Jefferson—Cross-member style (WeeRide Kangaroo)

In previous designs, attachment systems used with auxiliary bicycle seats include top tube mounts, stem or handlebar mounts, and top-tube or cross-member mounts. These attachment systems are often complicated, bulky, and cumbersome. They frequently require tools for installation and adjustment and cannot be completely and easily removed. Those attachment systems that are attached to the stem usually require that the child turn with the handlebars. This disrupts the balance and handling of the bicycle. Auxiliary bicycle seats using a top-tube attachment system may only work well with certain bicycle designs that have a horizontal top tube and that do not have cable routing along the top tube. Furthermore, many types of auxiliary bike seats restrain the occupant to some degree, making the use thereof uncomfortable and confining.

### DESCRIPTION OF THE DRAWINGS

FIG. 1 is an exploded assembly view of the invention.

FIG. 2 is a perspective view of the assembled invention.

FIG. 3 is a drawing of the invention mounted on a conventional bicycle.

### DETAILED DESCRIPTION

Auxiliary bicycle seats and attachments are disclosed herein. An auxiliary bicycle seat as described herein is used to support and carry a subject on a bicycle. For example, an auxiliary bicycle seat may be used to carry an adult, adolescent, or child on a bicycle. An auxiliary bicycle seat as disclosed herein comprises a single assembly including a sitting surface, or a seat or saddle, and a hand rest or handlebars, wherein the sitting surface, seat, or saddle of the auxiliary bicycle seat is separate and apart from the primary or main bicycle seat or saddle. In one embodiment, an auxiliary bicycle seat as disclosed herein comprises a single assembly that may be removed and attached to a bicycle without using tools and without any residual brackets or hardware left permanently affixed to the bicycle. In certain embodiments, the auxiliary bicycle seat disclosed herein is a single assembly that may be easily attached and removed from a bicycle regardless of frame design. In one such embodiment, an auxiliary bicycle seat as disclosed herein may be attached to a rigid-framed bicycle or a bicycle with a suspension frame. In another such embodiment, an auxiliary bicycle seat as disclosed herein may be attached to the seat post of a bicycle. In particular embodiments, an auxiliary bicycle seat as described herein may be accompanied by a foot rest attached to the bicycle frame.

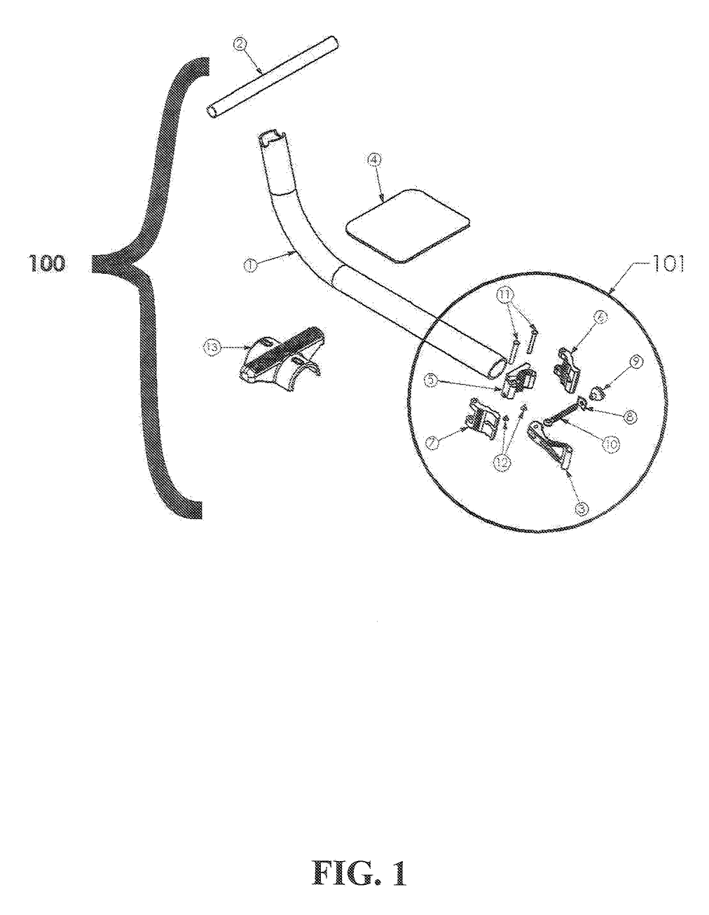

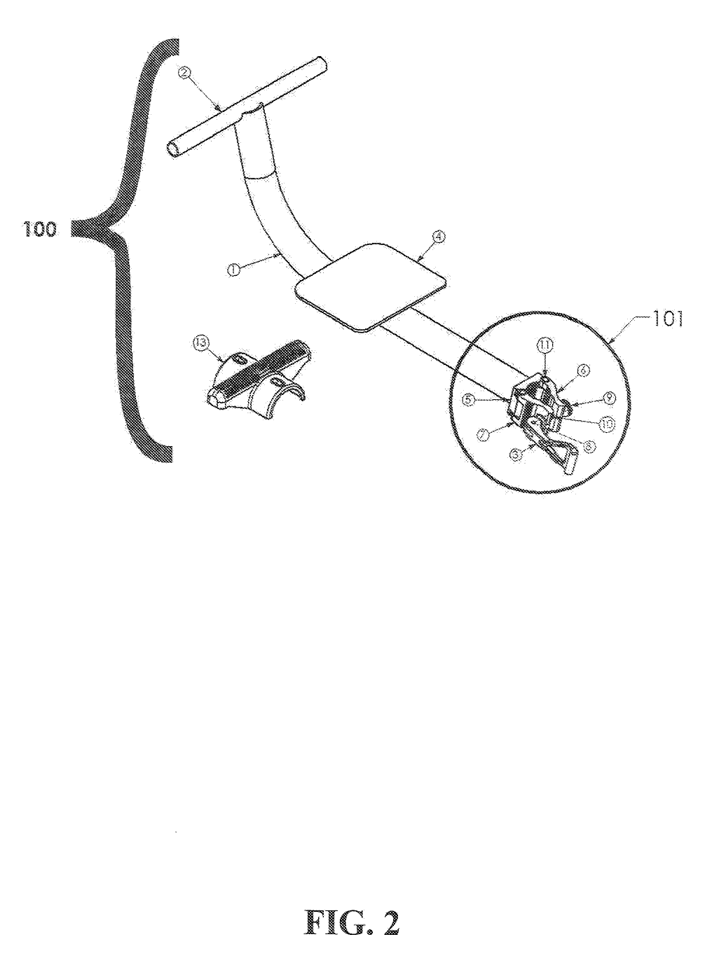

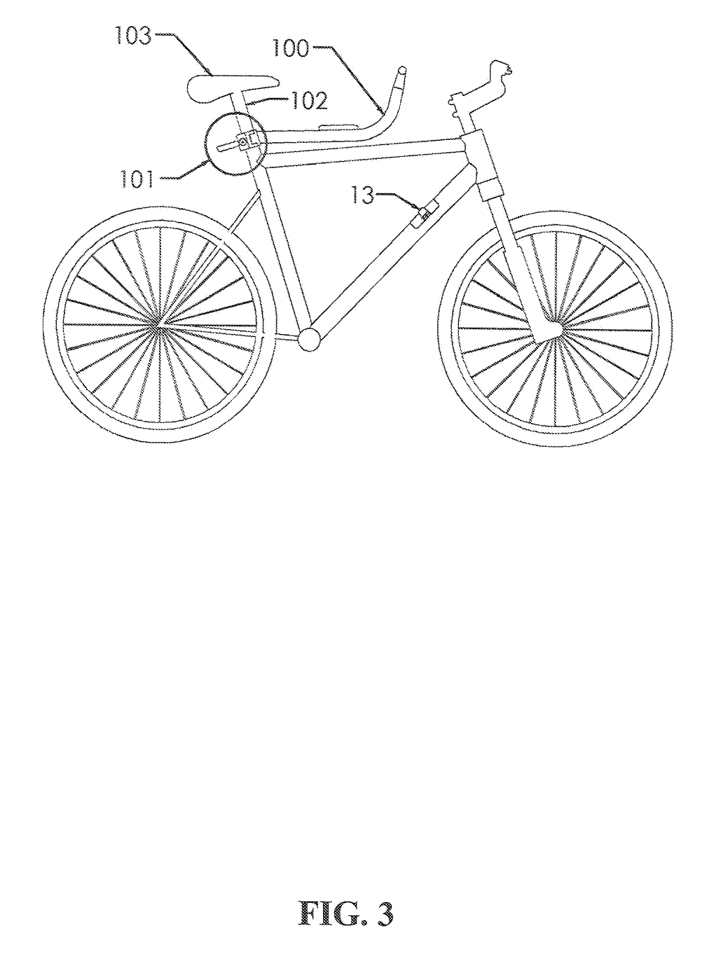

Referring to one embodiment of an auxiliary bicycle seat 100 depicted in FIGS. 1 and 2, there is shown a structural member 1 that may be configured to support a handlebar or hand rest 2 and a seat 4. In particular embodiments, the structural member 1 may be attached to a quick release mechanism 100 configured to allow the structural member 1 to be attached to the seat post 102 of a bicycle at one or more attachment points. In one such embodiment, the quick release mechanism 101 may be configured to allow the structural member 1 to attach to, or remove from, the seat post 102 of a bicycle without the use of any tools. In another such embodiment, the structural member 1 may comprise a quick release mechanism 101 comprising a clamp base 5, a clamp left wing 6, a clamp right wing 7, a curved washer 8, a nut 9, an eyebolt 10, a lever 3, rivets 11 and rivet caps 12. In a certain embodiment shown in FIG. 3, the structural member 1 is attached to a bicycle seat post 102 with or without the use of tools via the quick release mechanism 101, thereby providing an auxiliary seat for a passenger on a bicycle operated by another rider. In particular embodiments, the auxiliary bicycle seat 100 includes a seat 4 that is separate and apart from the primary bike seat 103. In another embodiment a foot rest 13 is attached to the bicycle frame in order to provide place for the passenger's feet. Alternate attachment systems may also be used to secure the auxiliary bicycle seat 100 to the bicycle.

In one embodiment of an auxiliary bicycle seat 100 disclosed herein and shown in FIGS. 1 and 2, the structural member 1 is of sufficient size and material to support an individual, such as an adult or a child, during normal operation of a bicycle. In another embodiment, the structural member 1 may be configured to keep the individual in a safe and comfortable position apart from the bicycle operator and other areas of the bicycle. For example, the auxiliary bicycle seat 100 described herein may be designed to be attached to a bicycle such that the individual riding on the auxiliary bicycle seat 100 is approximately 1 to 24 inches away from the primary bicycle saddle. In a particular embodiment, with reference to FIGS. 1 and 2, the auxiliary bicycle seat 100 includes a structural member 1 configured with a length of approximately 10 to 20 inches in length. In another embodiment, the auxiliary bicycle seat 100 may be of sufficient size to support a desired passenger or load. For example, the auxiliary bicycle seat 100 may be sized to accommodate a child. In a particular example, the auxiliary bicycle seat 100 may be sized to be approximately 6-12 inches wide by 6-12 inches long.

As shown in FIGS. 1 and 2, certain embodiments of an auxiliary bicycle seat 100 include a hand rest or handlebar, such as hand rest 2. In one embodiment, the hand rest 2 may be sized to accommodate a desired passenger. In one such embodiment, the hand rest 2 may be sized to accommodate a child's hands or an adult's hands. In a particular embodiment, the hand rest 2 may be about 0.75 inches in diameter. In another embodiment, the hand rest 2 may be covered with a grip, tape, or padding of some kind to provide a secure and/or comfortable hold. In one embodiment, the auxiliary bicycle seat 100 as disclosed herein could be used to carry dogs, cats or any other animal as well as equipment, packages, and any other item or subject that is desired by the user.

Methods for attaching an auxiliary bicycle seat to a bicycle are disclosed herein. In one embodiment, the methods disclosed herein for attaching an auxiliary bicycle seat comprise attaching the auxiliary bicycle seat to the seat post of a bicycle. In one such embodiment, the methods of attaching an auxiliary bicycle seat as disclosed herein comprise attaching the auxiliary bicycle seat to at least one attachment point on the seat post of a bicycle. In another such embodiment, a method for attaching an auxiliary bicycle seat comprises attaching the auxiliary bicycle seat with or without the use of tools. In particular embodiments, the methods disclosed herein for attaching an auxiliary bicycle seat comprise attaching the auxiliary bicycle seat to the seat post of a bicycle using a quick-release mechanism.

An auxiliary bicycle seat and any of its components disclosed herein may be fabricated from any material that provides the strength necessary to support the required loads such as steel, aluminum, plastic, polymer, composite, carbon fiber, or wood. In one embodiment, the auxiliary bicycle seat may be attached or mounted to the seat post of a bicycle. In one embodiment, the auxiliary bicycle seat disclosed herein may provide separate stationary handle bars. In another embodiment, the auxiliary bicycle seat disclosed herein may be a single assembly that can be completely attached and removed with or without tools. In yet another embodiment, the auxiliary bicycle seat disclosed herein is configured to avoid contacting the frame or stem of the bicycle when attached. In still another embodiment, the auxiliary bicycle seat as disclosed herein may allow an occupant to sit, stand and otherwise ride freely with or without restraint. In a particular embodiment, the auxiliary bicycle seat disclosed herein may be attached and removed by a quick release mechanism around the seat post. In other embodiments, the auxiliary bicycle seat as disclosed herein may be attached to a bicycle using a clamp, a bolt, a screw, a vice, adhesive, a bracket, or other appropriate attachment mechanism or means.

Those of ordinary skill will understand and appreciate the existence of alternate and additional variations, combinations, and equivalents of the specific embodiments, methods, and examples disclosed herein. The disclosure should therefore not be limited by the above described embodiments, methods, and examples, but by all embodiments and methods within the scope and spirit of the invention.

1. An auxiliary bicycle seat for use with a bicycle, the auxiliary bicycle seat comprising:
a seat;
a hand rest; and
an attachment mechanism for securing the auxiliary bicycle seat to at least one attachment point on the bicycle.

2. The auxiliary bicycle seat of claim 1, wherein the attachment mechanism attaches the auxiliary bicycle seat to a single attachment point on a seat post of the bicycle.

3. The auxiliary bicycle seat of claim 1, wherein the seat, the hand rest, and the attachment mechanism comprise a single assembly that may be attached to, or removed from, the bicycle with or without the use of tools.

4. The auxiliary bicycle seat of claim 1, further comprising a separate foot rest attached to the frame of the bicycle.

5. The auxiliary bicycle seat of claim 3, wherein the single assembly comprises a structural member for supporting the seat, the hand rest, and the attachment mechanism.

6. The auxiliary bicycle seat of claim 1, wherein the attachment mechanism comprises a quick-release mechanism.

7. The auxiliary bicycle seat of claim 6, wherein the quick-release mechanism comprises at least one of a clamp base, a clamp left wing, a clamp right wing, a curved washer, a nut, an eyebolt, a lever, rivets, and rivet caps.

8. The auxiliary bicycle seat of claim 3, wherein the single assembly comprises at least one of metal, plastic, composite, and wood.

9. The auxiliary bicycle seat of claim 1, wherein the attachment mechanism comprises an adjustable attachment mechanism.

10. The auxiliary bicycle seat of claim 1, wherein the bicycle comprises a primary bicycle seat and wherein the seat of the auxiliary bicycle seat is separate from the primary bicycle seat.

11. A method of attaching an auxiliary bicycle seat to a seat post of a bicycle, the method comprising:
providing an auxiliary bicycle seat comprising a seat, a hand rest, and an attachment mechanism;
attaching the auxiliary bicycle seat to at least one attachment point on the seat post of the bicycle with the attachment mechanism.

12. The method of claim 11, wherein the auxiliary bicycle seat may be attached to the bicycle with or without the use of tools.

13. The method of claim 11, wherein the attachment mechanism comprises a quick-release mechanism.

14. The method of claim 11, wherein the bicycle comprises a primary bicycle seat and wherein the seat of the auxiliary bicycle seat is separate from the primary bicycle seat.

15. The auxiliary bicycle seat of claim 11, wherein the seat, the hand rest, and the attachment mechanism comprise a single assembly that may be attached to, or removed from, the bicycle with or without the use of tools.
